(19) United States
(12) Patent Application Publication
(10) Pub. No.: US 2016/0100059 A1
(43) Pub. Date: Apr. 7, 2016

(54) AGENT NON-PRIMARY SKILL IMPROVEMENT TRAINING METHOD

(71) Applicant: Avaya Inc., Santa Clara, CA (US)

(72) Inventors: David Skiba, Golden, CO (US); Valentine C. Matula, Granville, OH (US); George Erhart, Loveland, CO (US)

(21) Appl. No.: 14/507,238

(22) Filed: Oct. 6, 2014

(51) Int. Cl. H04M 3/523; H04M 3/51

(52) U.S. Cl. CPC H04M 3/523; H04M 3/5175

(57) ABSTRACT

Agents of a contact center are trained and assessed without the need for a separate testing and assessment task. Work items are provided to agents, who are non-primary agents with respect to a particular skill associated with an attribute of a work item. With the controlled routing of the non-primary work items to the non-primary agent, the agent is provided with a chance to practice their non-primary skills, with the intention of improving said skills A number of successfully completed tasks may indicate the agent is entitled to “primary” designation and be provided with tasks having the attribute in the normal course of business.

### CROSS REFERENCE TO RELATED APPLICATIONS

This application claims the benefit of U.S. patent application Ser. No. 14/507,127, filed Oct. 6, 2014, entitled “AGENT QUALITY AND PERFORMANCE MONITORING BASED ON NON-PRIMARY SKILL EVALUATION”, Sheridan Ross Docket No. 4366-681, the entire disclosure of which is incorporated herein by reference.

### FIELD OF THE DISCLOSURE

The present disclosure is generally directed toward automatic routing of work items to agents for testing purposes.

### BACKGROUND

Training agents is an important aspect of contact center management. The training of agents is an ongoing struggle as the subject matter covered by the contact center changes as well the need for the agent to increase and improve on their portfolio of skills Contact center administrators generally operate with the assumption that, in most cases, it is cheaper to train existing agents with new skills than it is to hire new agents. The administrators are also charged with providing training programs to keep their agents' skills up to date. Having to manually manage training programs, ensure the agents receive their training, and the agents who receive their training have their training reported represents a portion of the significant challenges faced by administrators.

Maintaining a separate training and evaluation system expends resources that may be better applied to other activities, such as servicing customers. The need for a particular training often comes before the associated training program becomes is available. Furthermore, training tasks may be not be updated as quickly or as often as need to adequately relate to actual work items faced by the agents. Even if training systems are updated, accurate, and relevant, it is often disruptive to the performance of the contact center to pull an agent away from their regular duties for training or evaluation. Similarly, scheduling and paying an agent to attend a training or evaluation session, in addition to their normal work duties, incurs additional expenses and further burdens human and system resources.

### SUMMARY

It is with respect to the above issues and other problems that the embodiments presented herein were contemplated. In one embodiment, agent's non-primary skills are improved by the automatic and period assignment of non-primary work items for training and/or evaluation purposes.

Means for evaluating an agent with respect to a primary skill are generally well understood. For example, an agent who is a primary agent with respect to the skill of speaking a certain language, knowing details of a particular product, or other skill of a contact center can be measured by their sales, call volume, customer satisfaction, manager score, or other key performance indicators (KPIs) for that skill If, for example, an agent was erroneously considered a primary agent, but did not have the required skills, existing systems would soon realize that a problem existed as call times would increase, mid-call abandonments would increase, or other aspect of an agent simply not performing would become apparent. However, work items may provide a means to train or to assess an agent's ability. By inserting a controlled number of work items for which the agent is not a primary agent, they agent may improve their skills and, upon successfully processing a number of such work items, earn the designation of a primary agent. By controlling the number of non-primary work items and monitoring the agent's performance, adverse effects associated with non-primary work items (e.g., longer time, decreased customer satisfaction, etc.) may be attenuated within a larger pool of primary work items.

In one embodiment, a skill improvement training for an agent routes a work items to a non-primary agent (e.g., agents designated as being a non-primary agent with respect to a particular skill associated with an attribute of the work item). An administrator may designate rates for which work items are presented to agents to maintain the qualification “skilled” or “primary agent,” improve the skill level of the agent, and/or evaluate the skill level of the agent. For example, an agent listed as non-primary but having some skill conversing in Portuguese may receive a first number of calls from Portuguese speaking customers in order to maintain and hopefully improve that particular non-primary skill for the agent. As a benefit, work items may be selected for an agent, for processing by the agent, having the additional purpose of training and evaluation of an agent with respect to an attribute of the work item. As a further benefit, agents may be trained and evaluated while working on production work items for the contact center instead of, or at least in addition to, non-production items used solely for training and/or evaluation.

In one embodiment, an agent is selected to be an agent under test. The agent under test may be deficient with respect to a particular skill (e.g., a language, specific product, specific service type, upgrade selling, cross-selling, etc.). The agent under test may have at least a minimum proficiency with the skill, such as when the agent under test is a non-primary agent with respect to the skill and receives work items having an attribute associated with the skill for training purposes, as disclosed herein, and optionally for overflow purposes (e.g., no primary agent is available). The agent under test may or may not have other skills for which they have primary or non-primary status. The agent under test has been selected as requiring training, updating, or refreshing of a sub-skill through one of several methods, such as due to supervisor tagging, poor survey results, supervisor scheduling, new skill development indicator, etc.

One aspect of a selection/configuration criteria is the identification of the training skills required and the desired volume, rate, or other thresholds that may be utilized to determine the type and/or timing of a training activity. In one embodiment, the training activity may be a work item that is processed in the normal and customary way by the contact center but routed to an agent under test for the additional purpose of training or evaluating the particular agent under test's performance with respect to a skill associated with that work item.

The selection or timing of a training activity may be at a manager's discretion and/or determined by automatic means, such an algorithm selecting training activities based on previous success rates for a particular language, product, selling, agent feedback, customer feedback, or other aspect of the contact center. Guidance may be provided for the selection of training activities based on whether the objective is the evaluation or development of a skill For example, if the object is to give the agent more practice with Portuguese speaking customers, a greater frequency of work items from Portuguese speaking customers may be assigned to the agent under test. In another example, the agent has previously been found to be proficient in Portuguese, however Portuguese speaking customers are typically not routed to the agent, such as when Portuguese speaking customers are usually fluent in a more common language, such as Spanish and/or the technical or product issue associated with the Portuguese customers are typically routed to other agents). When new work items arrive in the contact center, or in the case of out-bound work items—created, a part of the routing decision may then consider if there are combination of work item attributes and agents designated to receive a training work item. Further consideration may be given to whether or not the work item is associated with a customer that has been previously been routed to a non-primary agent under test or is otherwise determined unsuitable for testing or training purposes (e.g., a high-value customer, a contractual obligation to provide only primary agents to the customer, etc.).

Once a training work item/agent under test match is determined, the work item is assigned to a selected agent under test with the skill or sub-skill as one routing element. Other routing elements may include any one or more of the routing elements utilized by the contact center for non-training work items. For example, an agent under test may be selected for training work items no more than once a day to with respect to a first skill, no more than once an hour to test a second skill, not at all if the contact center is falling behind a key performance metric, or other routing rule or rules as may be determined by the contact center. Assuming the work item is eligible to be routed to an agent under test, the work item may then be routed and the non-primary agent under test presented with the work item.

An evaluation is performed to determine if the training is proceeding satisfactorily and/or there is a determined success, failure, or score of the agent under test's performance. A post transaction survey, which may be unique for a particular training scenario, can be utilized in addition or alternative to live monitoring. For example, a supervisor can review the work item, such as by playing back a call or surveying a customer. Automated indicators and metrics may be provided, including first call resolution, sales amount, upsell success, customer satisfaction, etc.

Upon successful validation of training interactions, the agent under test may be taken out of the training-based routing and placed into the pool of skilled agent under tests (e.g., become a primary agent for the skill being tested for that agent). Upon unsuccessful validation of the training, the agent under test may be scheduled for more training interactions or the agent under test's supervisor may be notified for further actions.

The periodic assignment of non-primary work items provides training, assessment, advancement, and confirmation of an agent under test's skill with respect to non-primary skills With sufficient and appropriate frequency, the agent under test can improve, validate, and/or refresh their non-primary skills The frequency may be adjusted up or down based on the success of the agent under test. For example, an agent under test that is performing poorly, may receive fewer training work items, even zero. In contrast, an agent under test who successfully completes a training work item may be sent additional training work items at a greater frequency.

In an additional embodiment, the system may update the agent under test's skill based on the agent's performance being above a threshold value set by an administrator. For example, successfully processing one or more training work items, the agent under test may be designated a primary agent, promoted, or otherwise indicated as skilled with respect to the attribute of the training work item(s). Assessments may also be used to identify additional training needs and contribute data points to performance reviews. The work assignment engine may use the updated skill capabilities of an agent under test such that, if successfully promoted to primary agent with respect to a particular skill, is considered for work items having an attribute associated with that particular skill and requiring routing to a primary agent.

In one embodiment, an electronic system is disclosed, comprising: a work item categorization module configured to access a work item of a contact center, determine an attribute of the work item, and determine eligibility for the work item to be a training work item; a routing engine configured to, upon the work item being determined to be eligible to be a training work item: select an agent to be an agent under test from a pool of agents, wherein the selected agent has previously been determined to have a proficiency with the attribute that is below a primary agent status proficiency level; route the work item to the agent under test for processing by the non-primary agent; an evaluation module configured to evaluate the performance of the agent under test in processing of the work item, wherein the evaluation is associated with the attribute; and a reporting module to report indicia of the evaluated performance of the agent under test performed by the evaluation module to a report receiving component of the contact center.

In another embodiment, a non-transitory computer readable medium is disclosed with instructions thereon that when read by a computer cause the computer to perform: accessing a work item of a contact center; determining an attribute of the work item; determine eligibility for the work item to be a training work item; upon the work item being determined to be eligible to be a training work item: selecting an agent to be an agent under test from a pool of agents, wherein the selected agent has previously been determined to have a proficiency with the attribute that is below a primary agent status proficiency level; routing the work item to the agent under test for processing by the non-primary agent; evaluating the performance of the agent under test in processing of the work item, wherein the evaluation is associated with the attribute; and reporting indicia of the evaluated performance of the agent under test performed by the evaluation module to a report receiving component of the contact center.

In still another embodiment, a server is disclosed configured to: access a work item of a contact center; determine an attribute of the work item; determine eligibility for the work item to be a training work item; upon the work item being determined to be eligible to be a training work item: select an agent to be an agent under test from a pool of agents, wherein the selected agent has previously been determined to have a proficiency with the attribute that is below a primary agent status proficiency level; route the work item to the agent under test for processing by the non-primary agent; evaluate the performance of the agent under test in processing of the work item, wherein the evaluation is associated with the attribute; and report indicia of the evaluated performance of the agent under test performed by the evaluation module to a report receiving component of the contact center.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communication system in accordance with embodiments of the present disclosure;

FIG. 2 depicts a diagram for categorizing work items in accordance with at least some embodiments of the present disclosure;

FIG. 3 depicts a routing diagram in accordance with at least some embodiments of the present disclosure;

FIG. 4 depicts a processing diagram 400 in accordance with at least some embodiments of the present disclosure; and

FIG. 5 depicts a process in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

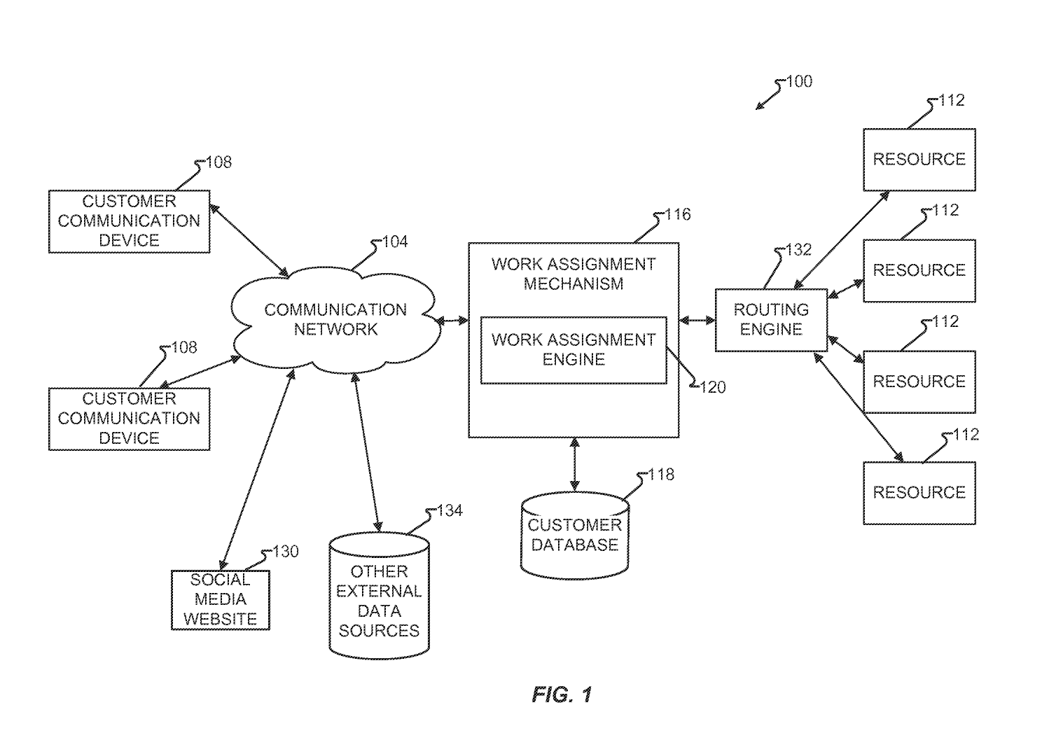

With reference now to FIG. 1, communication system 100 is now discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 and/or other external data sources 134 may be utilized to provide one means for a resource 112 to receive and/or retrieve contacts and connect to a customer of a contact center. Other external data sources 134 may include data sources such as service bureaus, third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to the contact center. Customer database 118 may be updated in response to a work item and/or input from resource 112 processing the work item.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

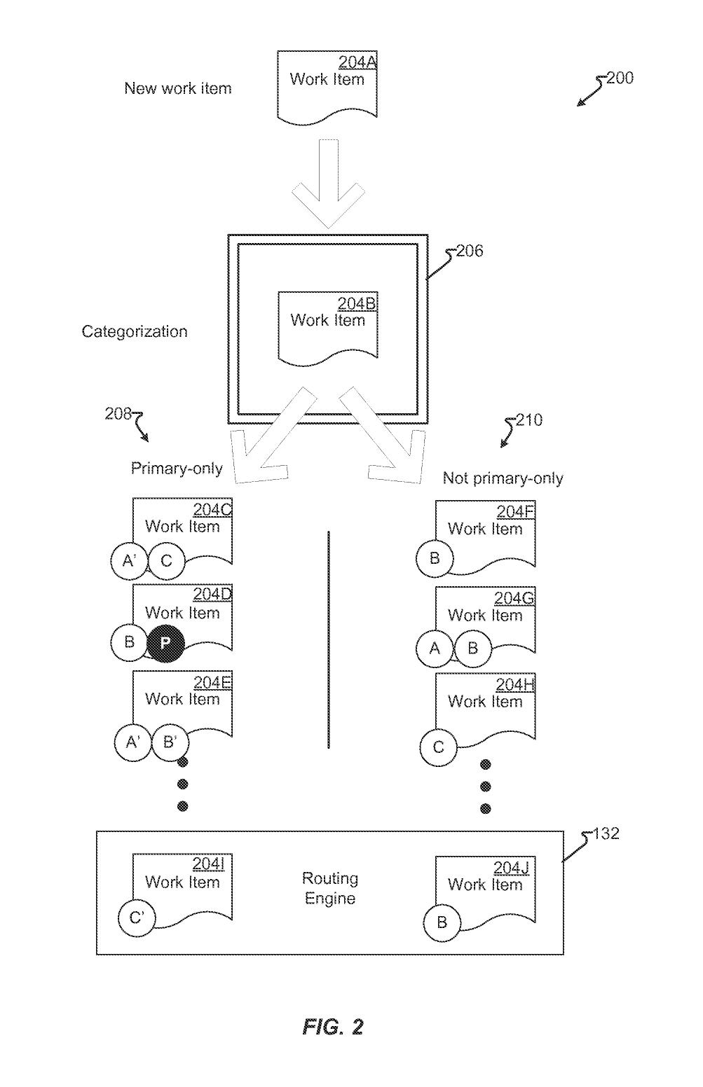

With reference now to FIG. 2, diagram 200 is described in accordance with at least some embodiments of the present disclosure. In one embodiment, a plurality of work items 204 are received, routed, and processed by a number of agents 112 (e.g., resources 112). While the embodiments disclosed herein are generally directed towards agents 112 being human agents of a contact center, those of ordinary skill in the art would appreciate that embodiments disclosed herein may be applied to non-human agent (e.g., IVR, machine learning systems, etc.) without departing from the teachings herein. Furthermore, diagram 200 illustrates work items 204 being processed in a manner analogous to the processing of physical items in a factory setting, whereby work items 204 move from one place to another, the illustration is provided for the promotion of understanding of the embodiments presented and not to suggest that work items 204 must be moved from process to process. As is known in the computing arts, data elements may be processed and modified in place, copied from one resource to another, moved (i.e., copied and deleted), or the combination thereof. Furthermore, data elements may be contiguously or diversely stored and/or processed, such as when one data element resides on one system component and another data element is modified by another system component.

In one embodiment, a new work item 204A is created by the contact center. New work item 204A may be an in-bound work item, wherein the work item is created in response to a customer action, or an out-bound work item, wherein the work item is created, at least in part, by a component of a contact center such as a resource 112. Work item 204A is then processed by categorization 206. Categorization 206 is illustrated as currently processing work item 204B. Categorization 206 determines if work item 204B is a primary-only 208 category or not primary-only 210 category.

At least one of categorization 206, routing 212, other evaluation components, or a combination thereof, determines at least one attribute of work items 204. The specific attribute utilized may be a matter of design choice, such as to coincide with the division labor for processing of work items 204 by resources 112 as determined by the contact center. For example, “telephone call” and “email” may be an attributes, whereas in another example, “inquiry to product X” is an attribute, in still another example, “German” is an attribute, and in yet another example, “iOS-expert level” is an attribute. What is utilized as an attribute may vary by contact center, directive from an enterprise directing the contact center, and/or event, such as workload, time, date, etc.

Once categorization 206 is complete, work items 204 may be considered to be primary-only 208 or non primary-only 210. Work items 204C-204H illustrate several determined attributes for work items 204, it should be readily apparent that more, fewer, or alternative attributes may be implemented without departing for the teachings provided herein. In one embodiment, work items 204C-204H have been assigned attributes and/or have had attributes identified. For example, work item 204C is an A′ (“A” primary-only) and C (“C” non primary-only) work item. As a result, work item 204C is directed towards an agent 112 who is a primary agent for attribute “A” and either a primary or a non-primary agent for attribute “C”.

A work item 204 may have at least one attribute resulting from categorization 206 or other process, such as “primary-only” which may simply have a binary value to indicate “yes” or “no.” As the name suggests, work items 204 having a non-primary only designation may be assigned to a primary agent 112 or to a non-primary agent 112. Work items 204 having a primary-only designation are to be assigned to a primary agent 204.

Work item 204D is directed towards a primary-only agent with respect to attribute “B”. Work item 204D may be directed towards a primary agent 112 such as due to the customer associated with work item 204D being a high-value customer, work item 204D being a reply or follow-up (e.g., indicating the initial work item was incomplete and/or erroneous and a primary agent is advised in order to promote swift resolution), the customer associated with work item 204D had a prior work item that was selected for routing to a non-primary agent (e.g., a desire not to subject any one customer to non-primary agents too frequently), or other aspect that may exclude a particular work item 204 from being directed to a non-primary agent even if the subject matter of the work item may otherwise allow for assignment to a non-primary agent.

Work item 204E is designated to be routed to one of agents 112 that is a primary agent for both skill “A” and skill “B.” Work item 204F does not require routing to a primary agent 112 for skill “B” so that an agent who is primary or non-primary with respect to skill “B” may receive work item 204F for processing. Work item 204G is designated to be routed to an agent 112 who is a primary or non-primary agent for skills “A” and “B”. Work item 204H is designated to be routed to an agent 112 who is a primary or a non-primary agent for skill C.

Work items 204C-204H is designated to be processed by routing engine 132. Routing engine 132 routes work items 204, such as work item 204I and 204J, as illustrated. Work item 204I is identified as being associated primary skill “C” and is designated for routing to an agent 112 who is a primary agent for skill “C”. Work item 204J, identified as being associated with not primary agent skill “B” and may be routed to either a primary agent 112 or a non-primary agent 112, with respect to skill “B”. Routing engine 132 may consider other traditional routing factors associated with contact center operation (e.g., load balancing, wait-time reduction, etc.) without departing from the embodiments disclosed herein. For example, the selection of a primary agent 112 or a non-primary agent 112, which both are acceptable routing options for a particular work item 204, may be determined by the impact upon the work load or other performance metric of the contact center. Other embodiments of routing engine 132 include serial processing and/or multiple routing engines 132. Once a work item 204 is routed to an agent 112, agent 112 processes work item 204.

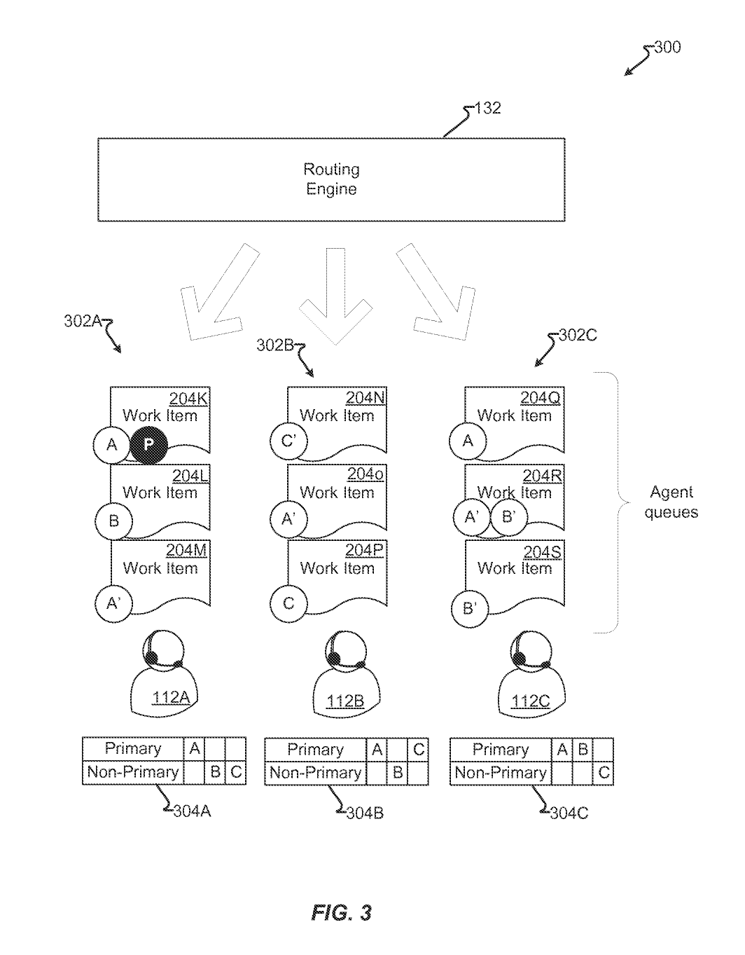

With reference now to FIG. 3, routing diagram 300 is described in accordance with at least some embodiments of the present disclosure. In one embodiment, routing engine 132 assigns work items 204 to agents 112. Ones of agent 112 receives work item 204 for processing and may have zero to many work items 204 waiting in their respective queues 302A, 302B, 302C for agents 112A, 112B, and 112C. As a result of certain embodiments described herein, agent 112A has enqueued work items 204K, 204L, 204M; agent 112B has enqueued work items 204N, 204o (lower case “o” is used for the avoidance of confusion with zero), 204P; and agent 112C has enqueued work items 204Q, 204R, 204S.

Agents 112 have an associated set of skills for which they are primary or non-primary agents. Agent 112A has skills 304A (e.g., primary for “A” and non-primary for “B” and “C”), agent 112B has skills 204B (e.g., primary for “A” and “C” and non-primary for “B”), and agent 112C has skills 204C (e.g., primary for “A” and “B” and non-primary for “C”). In one embodiment, agents 112 receive work items 204 having an attribute associated with their primary skill (i.e., a work item 204 for which they are a primary agent) and may go for a period of time, even a substantial period of time, without receiving a work item 204 for which they are a non-primary agent, as is disclosed with respect to certain embodiments disclosed herein. The frequency, timing, or volume of non-primary work items 204 that are sent to an agent may be determined by an objective, such as to “test the waters” of an agent's abilities, to stress-test the agent's abilities, or other objective. Similarly, agents 112 who are significantly deficient with respect to a skill may receive non-primary work items 204 only occasionally, such as when the agent 112 is improving their skills via additional methods. An agent 204 who is very close to being designated a primary agent may receive more work times associated with the skill Similarly, the frequency may be adjusted dynamically. For example, a non-primary agent 112 who performs well, may receive another non-primary work items 204 sooner than if they performed poorly.

In one embodiment, work item 204K is assigned to primary agent 112A as it has been identified as “for primary-only.” Work item 204L is assigned to a primary or a non-primary agent, in this case non-primary agent 112A. Work item 204M is assigned to primary agent 112A. Work item 204N is assigned to primary agent 112B, work item 204o is assigned to primary agent 112B, and work item 204P is assigned to primary agent 112B. Work item 204P has not been identified as requiring a primary agent, however, routing engine 132 selected primary agent 112B. Work item 204Q is assigned to primary agent 112C but would have been eligible for assignment to a non-primary agent 112. Work item 204R is assigned to primary agent 112C for both skill “A” and skill “B.” Work item 204S is assigned to primary agent 112C.

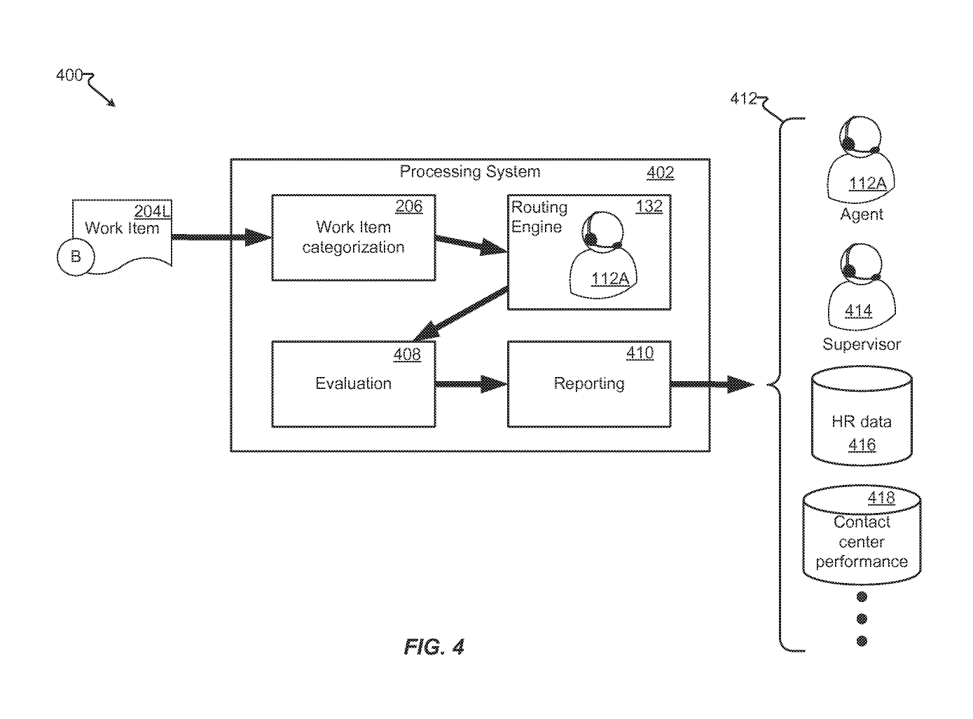

With reference now to FIG. 4, processing diagram 400 is described in accordance with at least some embodiments of the present disclosure. By way of an introduction and in one embodiment, non-primary only work item 204L is processed by processing system 402. Processing system 402 then reports to a report receiving component 412. Processing system 402 is variously embodied to include one or more electronic processors. Processing system 402 may be implemented as a component of a general or purpose-built processor having loaded instructions and/or circuitry for the execution of processing operations. Processing system 402 may be, without limitation, a single microprocessor, an Integrated Circuit (IC) chip, a plurality of IC chips, multi-core chip or chips, servers, distributed platform (e.g., cloud), etc. Processing system 402 may incorporate, be incorporated by, or co-hosted on a device with one or more components of FIG. 1, such as work assignment mechanism 116, work assignment engine 120, and/or routing engine 132.

Work item 204L is categorized by work processing component 206 and determined to be a non primary-only work item with respect to attribute “B” and therefore eligible to be routed, by routing engine 132, to agent 112A as a training work item. Evaluation component 408 may operate in real-time or offline to monitor the performance of agent 112A in handling work item 204L. Evaluation component 408 may include monitoring by a human, such as supervisor 414, as well as automated means. For example, work item 204L, if a voice work item, may be monitored for certain words or phrases, pause lengths, or other speech aspects. Additionally, the stress level of agent 112A and/or the associated customer, or the lack thereof, may indicate success or the lack of success. Reporting component 410 then provides the assessment to a report receiving component 412. Reporting component 410 may provide a summary, score, rank, pass/fail, a verbose itemization of the performance of agent 112A, or other desired report.

Report receiving component 412 may include, without limitation, one or more of agent 112A, supervisor 414, human resource database 416, contact center performance 418, and/or other interested persons or systems.

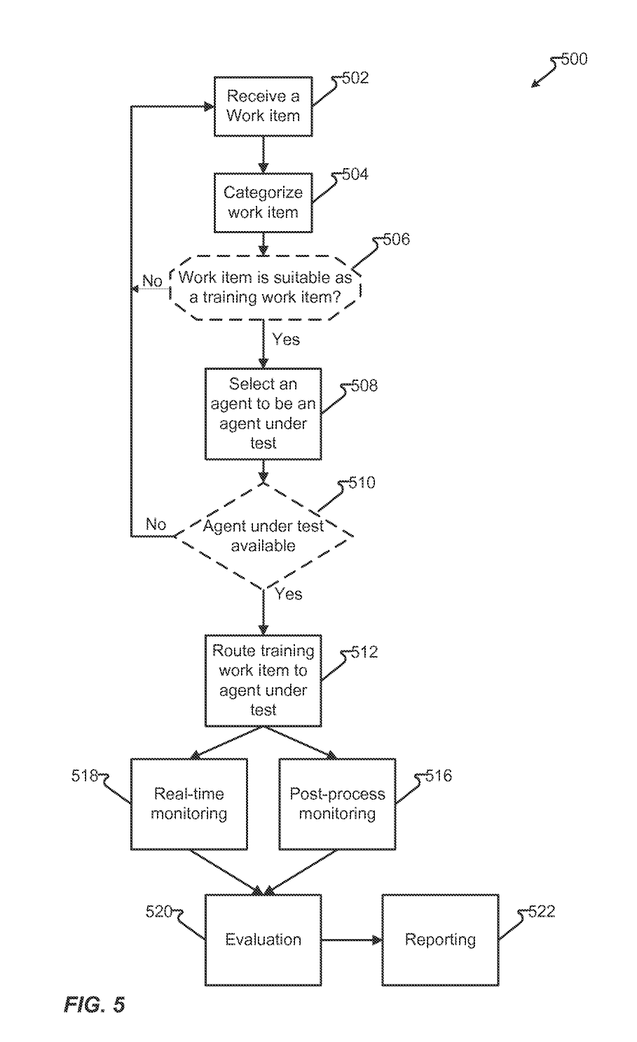

With reference now to FIG. 5, process 500 is described in accordance with at least some embodiments of the present disclosure. In one embodiment, step 502 receive a work item. Step 502 may be performed by work assignment mechanism 116 receiving a work item from communication network 140 (e.g., in-bound). Step 502 may also be the result of a component, such as work assignment mechanism 118 accessing customer database 118 to create work items (e.g., out-bound). Step 504 categorizes the work item. Step 504 may be performed by processing system 402, components thereof, and/or other components of the contact center.

Optionally, step 506 may determine if a work item is suitable to be a training work item. For example, a work item associated with a contractual obligation to only be routed to a primary agent, may disqualify the work item from being a training work item. If the work item is acceptable as a training work item, process 500 continues to step 508, otherwise processing may return to step 502. Step 508 selects an agent to be an agent under test.

Optional step 510 determines if an agent under test is available. For example, a selected agent under test may be selected in step 508 but that agent is not available to accept a training task for an unacceptable period of time. As a result, step 510 may be answered negatively and processing may then continue back to step 502. If step 510 is determined in the affirmative, or step 510 is omitted, processing continues to step 512.

Step 512 routes the training work item to the agent under test selected in step 508. At least one of step 518 and 516 are provided to monitor the performance of the agent under test in processing the training work item. As discussed above, real-time monitoring 518 and post-process monitoring 516 may be provided to determine aspects of the work item that indicate success, failure, or a relative performance of the agent under test. Step 520 evaluates the agent under test, such as by aggregating, scoring, assessing, or otherwise analyzing the results of the at least one of monitoring steps 518 and 516. Step 522 then reports the results of evaluation step 520 to one or more report receiving entities, such as one or more of entities 412.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An electronic system, comprising:
a work item categorization module configured to access a work item of a contact center, determine an attribute of the work item, and determine eligibility for the work item to be a training work item;
a routing engine configured to, upon the work item being determined to be eligible to be a training work item:
select an agent to be an agent under test from a pool of agents, wherein the selected agent has previously been determined to have a proficiency with the attribute that is below a primary agent status proficiency level;
route the work item to the agent under test for processing by the non-primary agent;
an evaluation module configured to evaluate the performance of the agent under test in processing of the work item, wherein the evaluation is associated with the attribute; and
a reporting module to report indicia of the evaluated performance of the agent under test performed by the evaluation module to a report receiving component of the contact center.

2. The system of claim 1, wherein the routing engine is further configured to, upon the work item not being determined eligible to be a training work item, selecting a primary agent and routing the work item to the selected primary agent for processing by the primary agent and not for processing by the agent under test.

3. The system of claim 1, wherein the evaluation module evaluates the performance of the agent under test in processing the work item and wherein the evaluation is further associated with an aspect of the work item other than the attribute.

4. The system of claim 1, wherein the routing selects the agent under test has previously been determined to have a proficiency with the attribute that is below a primary agent status proficiency level by failing to successfully process a prior work item having the attribute.

5. The system of claim 1, wherein the work item categorization module configured determine eligibility for the work item to be a training work item upon determining the work item is not associated with a customer that is further a associated with a previous work item that was routed to an agent under test within a previously determined time.

6. The system of claim 1, wherein the work item categorization module configured determine eligibility for the work item to be a training work item upon determining the work item has is not associated with a high-value customer of the contact center.

7. The system of claim 1, wherein the routing engine selects the agent under test in accord with a previously determined test frequency for the agent under test to receive work items that are determined to be training work items.

8. The system of claim 7, wherein the frequency is modified upon the evaluation module determining whether the agent under test successfully or unsuccessfully processed the work item.

9. The system of claim 1, wherein the routing engine selects the agent under test in accord with a previously determined test volume for the agent under test to receive a number of work items that are determined to be training work items until the previously determined test volume has been processed by the agent under test.

10. The system of claim 1, wherein the reporting module is operable to, upon the evaluation module determining that the agent under test has successfully processed the work item, cause the proficiency level of the agent under test associated with the attribute to be incremented.

11. A non-transitory computer readable medium with instructions thereon that when read by a computer cause the computer to perform:
accessing a work item of a contact center;
determining an attribute of the work item;
determine eligibility for the work item to be a training work item;
upon the work item being determined to be eligible to be a training work item:
selecting an agent to be an agent under test from a pool of agents, wherein the selected agent has previously been determined to have a proficiency with the attribute that is below a primary agent status proficiency level;
routing the work item to the agent under test for processing by the non-primary agent;
evaluating the performance of the agent under test in processing of the work item, wherein the evaluation is associated with the attribute; and
reporting indicia of the evaluated performance of the agent under test performed by the evaluation module to a report receiving component of the contact center.

12. The non-transitory medium of claim 11, further comprising instructions to, upon the work item not being determined eligible to be a training work item, selecting a primary agent and routing the work item to the selected primary agent for processing by the primary agent and not for processing by the agent under test.

13. The non-transitory medium of claim 11, wherein the instructions to evaluate the performance of the agent under test in processing the work item further comprise instructions to evaluate the agent under test with regard to an aspect of the work item other than the attribute.

14. The non-transitory medium of claim 11, wherein the instructions for selecting the agent under test, further comprise instructions to select the agent under test having previously been determined to have a proficiency with the attribute that is below a primary agent status proficiency level by failing to successfully process a prior work item having the attribute.

15. The non-transitory medium of claim 11, wherein the instructions to determine the eligibility for the work item to be a training work item, further comprise instructions to determine the work item is not associated with a customer that is further a associated with a previous work item that was routed to an agent under test within a previously determined time.

16. The non-transitory medium of claim 11, wherein the instructions for selecting the agent under test further comprise instructions to select the agent under test in accord with a previously determined test frequency for the agent under test to receive work items that are determined to be training work items and modifying the frequency upon determining whether the agent under test successfully or unsuccessfully processed the work item.

17. A server configured to:
access a work item of a contact center;
determine an attribute of the work item;
determine eligibility for the work item to be a training work item;
upon the work item being determined to be eligible to be a training work item:
select an agent to be an agent under test from a pool of agents, wherein the selected agent has previously been determined to have a proficiency with the attribute that is below a primary agent status proficiency level;
route the work item to the agent under test for processing by the non-primary agent;
evaluate the performance of the agent under test in processing of the work item, wherein the evaluation is associated with the attribute; and
report indicia of the evaluated performance of the agent under test performed by the evaluation module to a report receiving component of the contact center.

18. The server of claim 17, further comprising logic to, upon the work item not being determined eligible to be a training work item, select a primary agent and route the work item to the selected primary agent for processing by the primary agent and not for processing by the agent under test.

19. The server of claim 17, wherein the logic to evaluate the performance of the agent under test in processing the work item further comprise logic to evaluate the agent under test with regard to an aspect of the work item other than the attribute.

20. The server of claim 17, further comprising logic to, upon determining that the agent under test has successfully processed the work item, cause the proficiency level of the agent under test associated with the attribute to be incremented.
